(19) United States
(12) Patent Application Publication
(10) Pub. No.: US 2012/0066764 A1
(43) Pub. Date: Mar. 15, 2012

(54) METHOD AND APPARATUS FOR ENHANCING SECURITY IN A ZIGBEE WIRELESS COMMUNICATION PROTOCOL

(76) Inventor: Ho Won Kim, Busan (KR)

(21) Appl. No.: 13/319,062

(22) PCT Filed: Jan. 20, 2010
(86) PCT No.: PCT/KR2010/000365

§ 371 Date: Nov. 4, 2011

(30) Foreign Application Priority Data
May 6, 2009 (KR) 10-2009-0039250

(51) Int. Cl. H04W 12/08; H04L 9/00; H04L 9/08; H04W 12/04

(52) U.S. Cl. 726/22; 380/279

(57) ABSTRACT

The present invention relates to a technique for solving security vulnerability of a ZigBee wireless communication protocol frequently used as a low-power wireless communication protocol in a home network, a sensor network, or the like, and an apparatus therefor. An ACL security hardware block having diverse security functions is proposed, and a safe and reliable ZigBee wireless communication protocol is provided by applying a method of effectively detecting a replay attack, a method of efficiently managing a group key, and a method of detecting transmission of the same nonce value in advance.

### BACKGROUND OF THE INVENTION

1. Field of the Invention

The present invention relates to a method and apparatus for enhancing security of a ZigBee wireless communication protocol, which can solve security vulnerability of the ZigBee wireless communication protocol frequently used as a low-power wireless communication protocol in a home network, a sensor network, or the like.

2. Description of the Related Art

ZigBee, which is a low-rate wireless personal area network (LR-WPAN) protocol standardized by the ZigBee Alliance, is a protocol developed to be suitable for a small-scale low-power wireless sensor network, in which standards related to structure, routing, and security of a network are defined.

A relevant ZigBee wireless communication protocol is used together with the IEEE 802.15.4 protocol, which is a standard of the physical (PHY) layer and the MAC sub-layer, to implement ubiquitous application services.

Techniques of the ZigBee wireless communication protocol are expected to take an essential part in implementing a ubiquitous environment such as a home network, a process control, a smart grid, an Advanced Metering Infrastructure (AMI), a u-City, or the like.

However, conventional ZigBee wireless communication protocols suffer from security vulnerability such as (1) vulnerability to a replay attack, (2) vulnerability to a distributed denial-of-service (DDoS) attack made by maliciously using a replay preventing function, (3) lack of a group key management function needed when secure communication is performed for a plurality of nodes, and (4) vulnerability caused by the fact that important key values can be derived if the same nonce value is consecutively transmitted when packets are transmitted.

If the ubiquitous application services are implemented using the ZigBee wireless communication protocol techniques while the problems of security vulnerability are not solved, the ubiquitous application services may not succeed in the market due to the serious security vulnerabilities.

The conventional ZigBee wireless communication protocols provide security functions for outgoing messages to each of the network layer and the Application Support Sublayer (APS), and define a small number of security functions such as a method of setting keys among ZigBee nodes, a method of transmitting the keys, and the like. In addition, a master key, a network key, and a link key are defined in the ZigBee environment, and they are defined in the standard specifications to provide a suitable security function as needed.

However, although the security functions are defined as described above, the conventional ZigBee wireless communication protocols have serious security vulnerabilities as described above.

Particularly, the conventional ZigBee wireless communication protocols are extremely vulnerable to a replay attack and has a structure that cannot use a group key needed for performing secure communication among a plurality of nodes. Furthermore, since the same nonce value is transmitted in the same manner, the conventional ZigBee wireless communication protocols have security vulnerability in that important key values can be induced. A technique for preventing the security vulnerabilities is not defined in the ZigBee standard.

Security techniques defined in the other wireless communication protocols cannot be used in the ZigBee environment.

### SUMMARY OF THE INVENTION

Accordingly, the present invention is conceived to solve the problems of security vulnerability of the conventional ZigBee wireless communication protocols. It is an object of the present invention to provide a method and apparatus for enhancing security of a ZigBee wireless communication protocol, which can solve the security vulnerability of the ZigBee wireless communication protocol that is frequently used as a low-power wireless communication protocol in a home network, a sensor network, or the like.

Another object of the present invention is to provide a method and apparatus for enhancing security of a ZigBee wireless communication protocol, in which a structure of an Access Control List (ACL) security hardware apparatus suitable for a ZigBee wireless communication environment is provided, and thus the problem of security vulnerable to a replay attack can be solved.

A further object of the present invention is to provide a method and apparatus for enhancing security of a ZigBee wireless communication protocol, which can solve the problem of security vulnerable to a DDoS attack made by maliciously using a replay preventing function.

A yet further object of the present invention is to provide a method and apparatus for enhancing security of a ZigBee wireless communication protocol, which enables management of a group key needed for secure communication among a plurality of nodes.

Still further object of the present invention is to provide a method and apparatus for enhancing security of a ZigBee wireless communication protocol, in which transmission of the same nonce value can be detected in advance, and thus it is possible to solve the problem of security vulnerability caused by the fact that important key values can be derived if the same nonce value is consecutively transmitted when packets are transmitted.

According to an aspect of the present invention for achieving the objects, there is provided an apparatus for enhancing security of a ZigBee wireless communication protocol, provided in a node configuring a ZigBee wireless sensor network, wherein the node comprises: a nonce value analyzing block for analyzing a nonce value for transmission packets; a same-nonce value generation sensing block for confirming whether or not a same nonce value exists in consecutively transmitted packets; an ACL security block having identification information of another node configuring a wireless sensor network and information needed in relation to security; and a replay attack detecting block for retransmitting a packet transmitted from a specific node in order to prevent a replay attack.

In addition, the node configuring the ZigBee wireless sensor network further comprises a group key management and communication control block for providing a group key management function for secure communication between groups or between a group and a gateway.

In addition, the ACL security block includes: a region for storing information on node identification; a region for storing a secret key value of a corresponding node; a region for storing a frame counter value of a packet received from the corresponding node; and a region for storing a sequence value of an acknowledgement (ACK) signal received from the corresponding node.

In addition, the ACL security block prevents a replay attack and detects a DDoS attack by managing frame counter information and ACK sequence information of a message transmitted from each sensor node.

In addition, the ACL security block enables group key-based many-to-many secure communication by storing and managing ID information of a sensor node configuring the sensor network and secret key value information allowing secure communication with the sensor node.

According to another aspect of the present invention, there is provided a method for enhancing security of a ZigBee wireless communication protocol for detecting the replay attack in a ZigBee wireless sensor network in real-time, the method comprising the steps of: analyzing a received message, extracting a frame counter value, and comparing the frame counter value with a stored frame counter list; determining possibility of a replay attack by comparing the frame counter value of the newly received message with frame counter storage information of N previously received messages; and comparing the frame counter value of the newly received message with a stored frame counter value if it is determined that there is possibility of the replay attack, wherein a corresponding message is dropped depending on a result of the comparison.

In addition, in the step of determining possibility of the replay attack, if the frame counter value of the newly received message is equal to a largest existing value+1 or is a value for stuffing of an empty frame counter, it is determined that there is no possibility of the replay attack, and the corresponding frame counter list is updated.

In addition, in the step of comparing the frame counter value of the newly received message with the stored frame counter value, if the frame counter value of the newly received message exists in the previously stored frame counter value list, it is determined that the replay attack has been made, and a corresponding message is dropped.

In addition, in the step of comparing the frame counter value of the newly received message with the stored frame counter value, if the frame counter value of the received message is larger by two or more than the stored frame counter value and smaller than or equal to N-threshold, it is determined whether or not a routing transmission delay has occurred for a specific packet, and if the routing transmission delay has not occurred, this means that the replay attack has been made, and a monitoring center is informed of the occurrence of the replay attack.

In addition, in the step of comparing the frame counter value of the newly received message with the stored frame counter value, if the frame counter value of the received message is larger by N-threshold or more than the stored frame counter value, it is determined that a DDoS attack has been made, and a corresponding message is dropped.

According to a further aspect of the present invention, there is provided a method for enhancing security of a ZigBee wireless communication protocol for managing a group key for many-to-many secure communication between ZigBee nodes in a ZigBee wireless sensor network, the method comprising the steps of: confirming information on a network configuration state; setting node ID and a corresponding secret key value of each node to be suitable for the network configuration state; performing secure communication using the secret key value of a corresponding node; and determining whether or not there is a change in the network configuration, and processing information on a corresponding node and a key value of the node depending on a result of the determination.

In addition, in the step of determining whether or not there is the change in the network configuration, if it is determined that a new node has joined the network, information on the corresponding node and a key value of the node are stored, and if an existing node leaves the network, the information on the node and the key value of the node are deleted.

According to a still further aspect of the present invention, there is provided a method for enhancing security of a ZigBee wireless communication protocol for confirming a same nonce value for consecutive transmission messages in a ZigBee wireless sensor network, the method comprising the steps of: analyzing packets transmitted to a wireless transceiver; confirming whether or not same nonce value information (source address, frame_counter, and security control) is transmitted in two or more packets when ZigBee transmission packets are configured and transmitted; and transmitting an error value to a monitoring center if the same nonce value is transmitted.

### BRIEF DESCRIPTION OF THE DRAWINGS

FIG. 1 is a view showing the concept of secure communication among nodes configuring a ZigBee-based multiple wireless sensor network.

FIG. 2 is a block diagram showing the configuration of a ZigBee wireless sensor network with enhanced security according to the present invention.

FIG. 3 is a block diagram showing the configuration of an ACL security hardware block having a security function according to the present invention.

FIG. 4 is a flowchart illustrating a process of detecting a replay attack according to the present invention.

FIG. 5 is a flowchart illustrating a process of managing a group key inside an ACL security block according to the present invention.

FIG. 6 is a flowchart illustrating a process of confirming generation of the same nonce value according to the present invention.

### DESCRIPTION OF THE PREFERRED EMBODIMENT

Hereinafter, preferred embodiments of a method and apparatus for enhancing security of a ZigBee wireless communication protocol according to the present invention will be described in detail.

Features and advantages of the method and apparatus for enhancing security of a ZigBee wireless communication protocol according to the present invention will be clarified hereinafter through detailed descriptions on the embodiments.

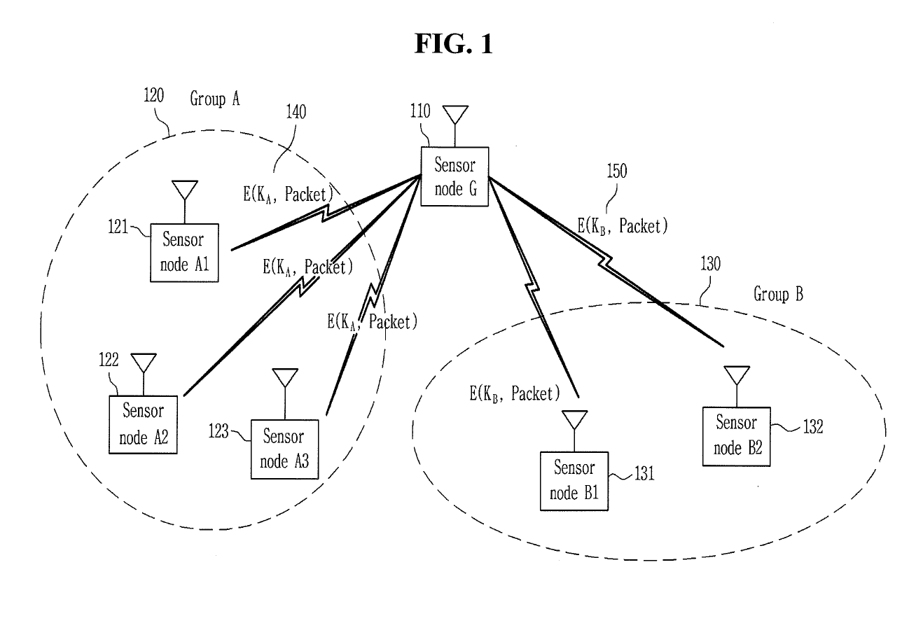

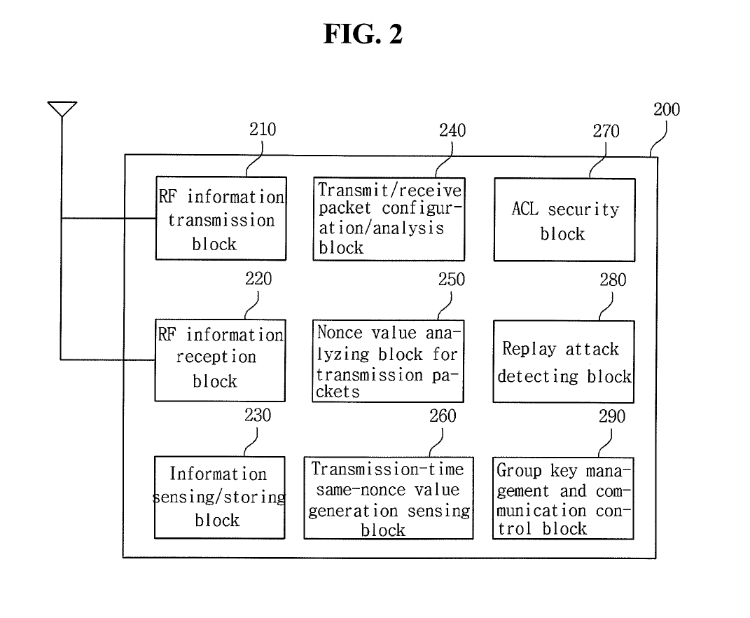

FIG. 1 is a view showing the concept of secure communication among nodes configuring a ZigBee-based multiple wireless sensor network, and FIG. 2 is a block diagram showing the configuration of a ZigBee wireless sensor network with enhanced security according to the present invention.

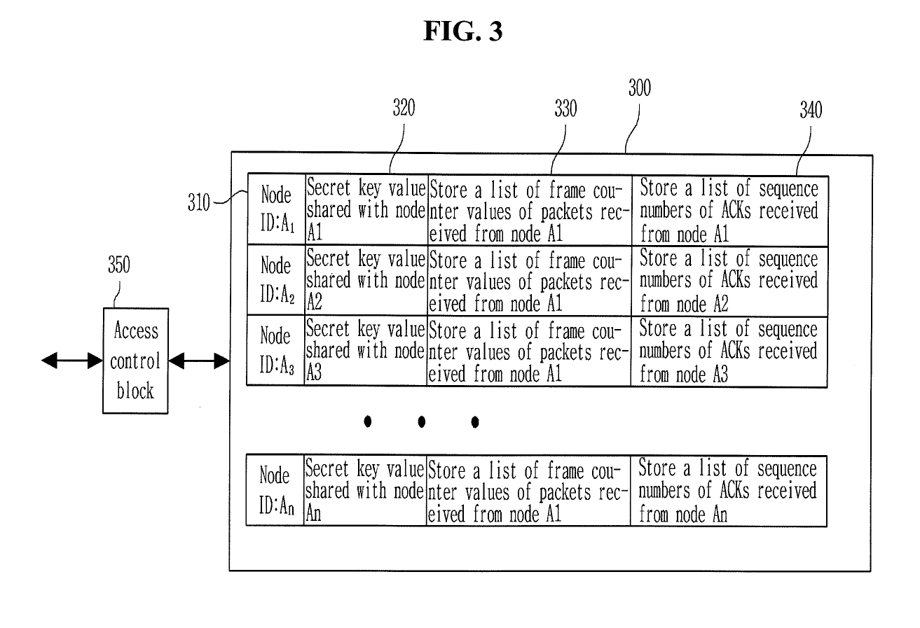

FIG. 3 is a block diagram showing the configuration of an ACL security hardware block having a security function according to the present invention.

The ACL security hardware apparatus according to the present invention has a basic security structure for solving security vulnerability of the ZigBee wireless communication protocol, such as (1) vulnerability to a replay attack, (2) vulnerability to a distributed denial-of-service (DDoS) attack made by maliciously using a replay preventing function, (3) lack of a group key management function needed when secure communication is performed for a plurality of nodes, and (4) vulnerability caused by the fact that important key values can be derived if the same nonce value is consecutively transmitted when packets are transmitted.

That is, the basic security structure includes a region for storing information on node ID, a region for storing a secret key value needed to communicate with an opponent node, a region for storing a frame counter value of a message received from the opponent node, and a region for storing a sequence value of an acknowledgement (ACK) signal received from the opponent node.

The ACL security hardware apparatus proposed in the present invention may prevent a replay attack and a DDoS attack, manage a group key, and protect a continuous transmission attack for the same nonce value.

A method of effectively detecting a replay attack is accomplished by properly using the ACL security hardware apparatus. The replay attack is detected in real-time by appropriately storing/managing/comparing a frame counter value of a message received from a communication opponent node.

A group key management method for efficiently performing many-to-many secure communication among a plurality of ZigBee nodes solves the problem of a ZigBee wireless communication module managing only two secret key values in maximum so that safe and reliable secure communication can be performed among a plurality of nodes by the ACL security hardware apparatus and a many-to-many secure communication control logic in the present invention.

In addition, a method of detecting transmission of the same nonce value in advance is used to solve a security problem that may occur when the same nonce value is undetected although the ZigBee wireless communication protocol generates the same nonce value.

The configuration and operating principle of the technique and apparatus for enhancing security in the ZigBee wireless communication protocol according to the present invention will be described below.

The concept of secure communication among nodes configuring a ZigBee-based multiple wireless sensor network is as shown in FIG. 1.

First, the wireless sensor network includes a sensor node 110 functioning as a gateway and sensor nodes 121, 122, 123, 131 and 132 configuring a sensor field.

The sensor nodes configuring the sensor field can be configured in a topology of a star, a tree, or a mesh depending on the configuration method of a network. The sensor node 110 functioning as a gateway receives information from the sensor nodes configuring the sensor field and provides the information to an external application service, and receives a control command from the external application service and transfers the control command to the sensor nodes configuring the sensor field.

In order to perform secure communication among the sensor nodes, the sensor node A₁ 121 and the sensor node G 110 share secret key information referred to as K_{A}. The secret key value is used as a key value of the Advanced Encryption Standard (AES) encryption algorithm and provides confidentiality and integrity of communication data between the sensor node A₁ 121 and the sensor node G 110.

This is described by a mathematical expression such as E(K_{A}, Packet) 140 of FIG. 1, which means that communication data Packet is encrypted into E (Encryption) using the key value K_{A}.

FIG. 1 shows the concept of secure communication between groups, and there are two groups, i.e., group A and group B.

Group A 120 includes sensor nodes A₁ 121, A₂ 122, and A₃ 123, and the group B 130 includes sensor nodes B₁ 131 and B₂ 132. Each of these groups shares its own group key KA or KB with the sensor node G 110 and uses a corresponding key for secure communication within the group, communication between the group and the sensor node G 110, and communications between group A and group B.

For example, in the case where group A communicates with the sensor node G 110, group A uses K_{A} as shown in E(K_{A}, Packet) 140, and in the case where group B communicates with the sensor node G 110, group B uses K_{B} as shown in E(K_{B}, Packet) 150.

The concept of secure communication proposed herein is a very important concept in a real wireless sensor network environment. Examples of the cases where secure communication is needed between groups will be described below.

For better understanding, it is assumed that group A and group B are wireless sensor networks installed in different homes in an apartment complex. At this point, group A and group B communicate using different encryption keys (i.e., the same encryption key within the same home), and the property management office of the apartment has K_{A} and K_{B} in order to process important information transmitted from the wireless sensor network installed in each corresponding home.

FIG. 2 is a block diagram showing the configuration of a ZigBee wireless sensor network with enhanced security according to the present invention.

The sensor node with enhanced security according to the present invention generally includes an RF information transmission block 210 and an RF information reception block 220 for transmitting and receiving RF information, an information sensing/storing block 230, a transmit/receive packet configuration/analysis block 240, a nonce value analyzing block 250 for transmission packets, a transmission-time same-nonce value generation sensing block 260, an ACL security block 270, a replay attack detecting block 280, and a group key management and communication control block 290.

Here, the RF information transmission block 210 is a wireless communication block used so that a ZigBee-compatible sensor node wirelessly transmits information to outside, and the RF information reception bock 220 is a wireless communication block used so that the ZigBee-compatible sensor node wirelessly receives information from outside.

The information sensing/storing block 230 is a block used so that a sensor node senses information on external environments (e.g., temperature, humidity, illuminance, movement and the like) and stores the sensed information, which a block is needed for a general sensor node, and the transmit/receive packet configuration/analysis block 240 is used so that the sensor node configures a packet wirelessly transmitted to outside and analyzes a packet received from outside.

The nonce value analyzing block 250, among the blocks performing a security function, which analyzes a nonce value for transmission packets, is used to solve security vulnerability of the current ZigBee standard.

According to the ZigBee standard, consecutively transmitted packets have nonce values different from one another. However, in a real application environment, nonce values of consecutively transmitted packets may be the same due to a variety of reasons such as a glitch, instability of power, erroneous operation, memory erasure, and the like.

This may be caused by a method of generating a nonce value defined in the existing ZigBee standard. In addition, if the nonce values of the consecutively transmitted packets are the same, key values may be leaked out. Therefore, in the present invention, the consecutively transmitted packets are analyzed, and error information is provided to the system if the same nonce value is consecutively transmitted.

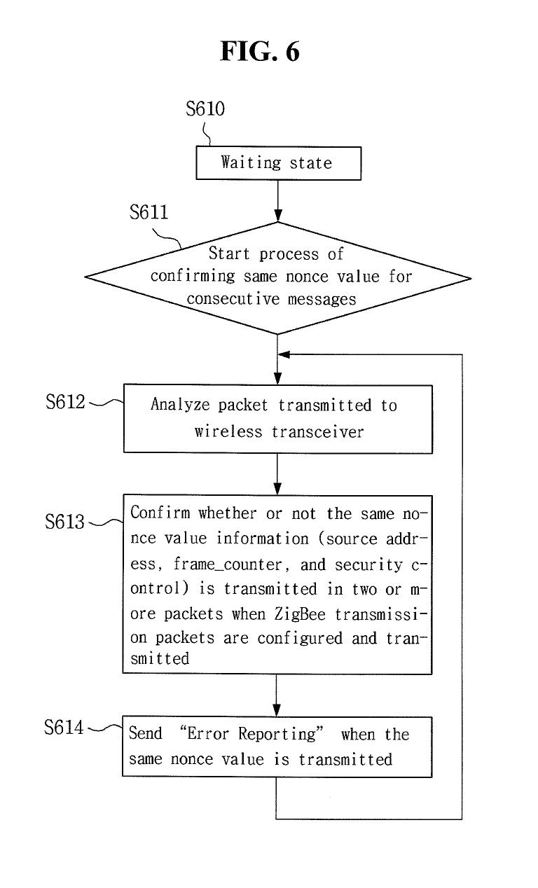

The process of confirming whether or not the same nonce value exists in the consecutively transmitted packets is performed by the same-nonce value generation sensing block 260 as shown in FIG. 6.

In addition, the ACL security block 270 has identification information of the other nodes configuring the wireless sensor network and information needed in relation to security.

In addition, the replay attack detecting block 280 protects a replay attack aiming at service disturbance, forgery and falsification, authentication acquisition, and the like by intercepting packets transmitted from a specific node and retransmitting the packets, and the group key management and communication control block 290 provides a group key management function for secure communication between groups or between a group and a gateway, which is not specified in the current ZigBee standard at all.

FIG. 3 is a view showing the ACL security hardware block structure 300 according to the present invention.

The current ZigBee standard technique having a technique referred to as Access Control List (ACL) is incapable of processing a group key and does not have a function for protecting a DDoS attack that can be made by manipulating a frame counter value.

In addition, there is no method for protecting a DDoS attack made by manipulating a sequence number of an acknowledgement signal.

The ACL security hardware block of FIG. 3 can efficiently manage a plurality of group keys and has an ACL structure for solving the security vulnerability.

The ACL security block generally includes a region for storing information on node identification 310, a region for storing a secret key value of a corresponding node 320, a region for storing a frame counter value of a packet received from the corresponding node 330, and a region for storing a sequence value of an acknowledgement signal received from the corresponding node 340.

The ACL security block stores information on n nodes in maximum, and the ACL security block exists as many as the number of sensor nodes included in a network when the network is configured. If a specific node is dropped out of the network or abnormally operates, corresponding information may be replaced by information on another node. Meanwhile, since the ACL security hardware block stores important information such as a key value, it has an access control characteristic 350.

Hereinafter, a process of detecting a replay attack, a process of managing a group key, and a process of confirming generation of a same-nonce value for enhancing security of the ACL security hardware block will be described.

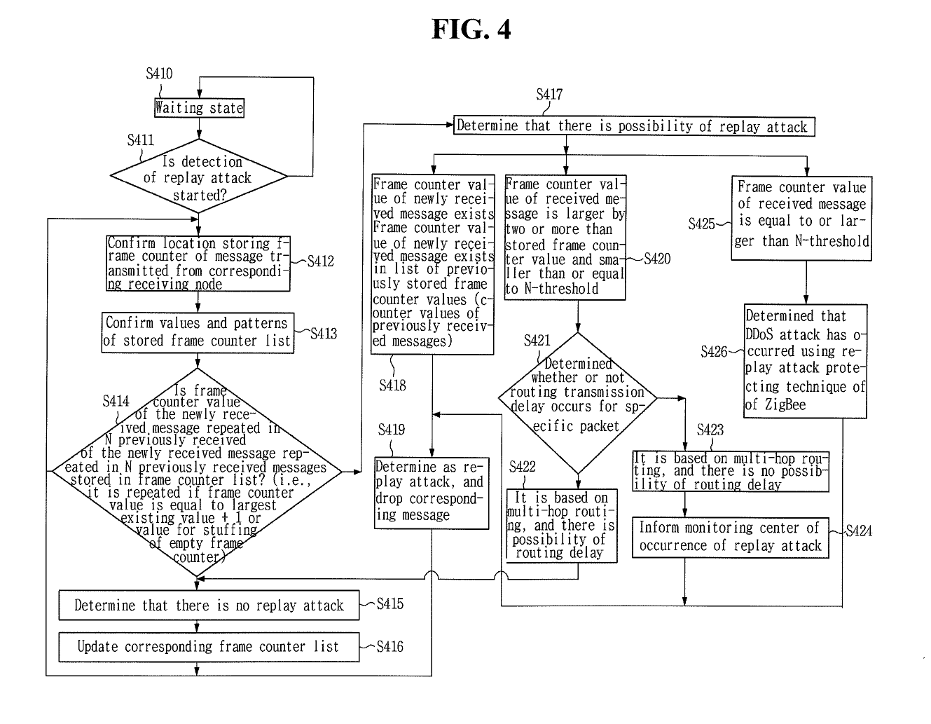

First, FIG. 4 is a flowchart illustrating a process of detecting a replay attack, which shows a process of detecting a replay attack using a frame counter value stored in the ACL security block.

When the ACL security block is in a waiting state (S410), a replay attack detecting algorithm starts detecting a replay attack in response to a replay attack detection start command (S411).

A location storing the frame counter of a corresponding node is confirmed by analyzing information on a source node (node identification information) of a message received from outside (S412).

Next, a frame counter value is extracted by analyzing the received message, and the frame counter value is compared with a stored frame counter list (S413).

The frame counter value of the newly received message is compared with information on stored frame counters of N previously received messages (S414), and if the frame counter value is equal to the largest existing value+1 or is a value for stuffing an empty frame counter, this may be regarded as a normal reception.

In this case, it may be determined that there is no possibility of a replay attack (S415).

If a replay attack does not exist as described above, the frame counter value of the newly received message is stored in a corresponding region of the ACL security block (S416). Meanwhile, the structure of memory for storing the frame counter list is constructed in the form of a ring, and thus the storage space can be reduced depending on settings of the ACL security block.

If it is determined that there is possibility of a replay attack (S417), it is confirmed whether or not the frame counter value of the newly received message exists in the list of stored frame counter values (frame counter values of previously received messages) (S418).

If the frame counter value of the newly received message exists, it is confirmed that a replay attack has been made, and a corresponding message is dropped (S419).

On the other hand, it is determined whether or not the frame counter value of the received message is larger by two or more than the stored frame counter value and smaller than or equal to N-threshold (S420). This is because the frame counter value of a message received after experiencing a routing delay may be larger than the stored frame counter value in a wireless communication section. That is, if a certain message arrives late in the middle of communication, such a case may occur. In this case, it is determined whether or not a routing transmission delay statistically occurs for a specific packet (S421).

If a delay time occurs, it is determined that the delay time occurs due to routing delay in multi-hop routing (S422), and a frame counter value for the received message is stored, and then the process goes to the receiving step.

However, if it is determined that there is no reason why the routing delay time occurs (S423), this means that a replay attack has been made, and the monitoring center is informed of the replay attack (S424).

On the other hand, if the frame counter value of the received message is larger by N-threshold or more than the stored frame counter value (S425), it is determined that a DDoS attack has been made (S426).

Meanwhile, it is defined in the present invention that a sensor manager may re-set the N-threshold value from outside depending on the security class and security policy.

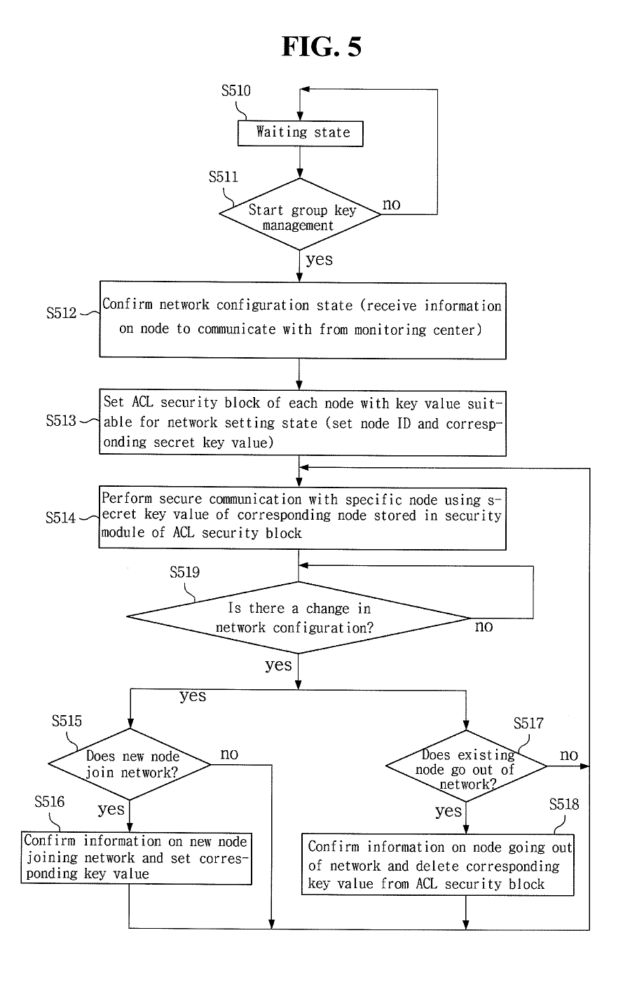

FIG. 5 shows a process of managing a group key inside the ACL security block. First, when the ACL security block is in a waiting state (S510), a group key management starts (S511). Then, the ACL security block is information on a network configuration state is confirmed (S512).

This is confirmed to identify information on which group a correspondence node belongs to and which group a node itself belongs. That is, it means that the node receives information on the correspond node with which the node is to communicate from the monitoring center.

In addition, the ACL security block of each node is set with a key value suitable for a network configuration state. That is, a node ID and a corresponding secret key value are set (S513), and secure communication is performed using the secret key value of a corresponding node stored in a security module (S514).

If there is a change in the network configuration (S519), a process is performed with respect to the change. A case where a new node joins (S515) and a case where an existing node does not operate or goes out of the network (S517) may be considered.

If a new node joins the network, information on the node and a key value of the node are stored in the ACL security hardware block (S516).

If an existing node leaves the network (S517), the information on the node and the key value of the node are deleted from the ACL security hardware block (S518).

FIG. 6 shows a process of confirming generation of the same nonce value at the time of transmission. First, when the ACL security block is in a waiting state (S610), the process of confirming the same nonce value for consecutive transmission messages starts (S611). Then, packets transmitted to a wireless transceiver are analyzed (S612).

It is confirmed whether or not the same nonce value information (source address, frame counter, and security control) is transmitted in two or more packets when ZigBee transmission packets are configured and transmitted (S613), and an error value is transmitted to the monitoring center if the same nonce value is transmitted (S614).

Meanwhile, whether or not the same nonce value is consecutively generated may be detected by storing previous transmission information inside the RF information transmission block 210 at all time and monitoring the previously stored transmission information in the transmission-time same-nonce value generation sensing block 260.

The method and apparatus for enhancing security of a ZigBee wireless communication protocol according to the present invention described above prevents a replay attack and a DDoS attack, manages a group key, and protects a continuous transmission attack for the same nonce value. Thus, it is possible to solve security vulnerability of the ZigBee wireless communication protocol that is frequently used as a low-power wireless communication protocol in a home network, a sensor network, or the like.

From the method and apparatus for enhancing security of a ZigBee wireless communication protocol according to the present invention so constructed, the following effects can be expected.

First, a structure of an ACL security hardware apparatus suitable for a ZigBee wireless communication environment is provided, and thus the problem of security vulnerable to a replay attack can be solved.

Second, the problem of security vulnerable to a DDoS attack made by maliciously using a replay preventing function is solved, and thus security of the ZigBee wireless communication protocol can be enhanced.

Third, management of a group key needed for secure communication among a plurality of nodes is allowed, and thus security of the ZigBee wireless communication protocol can be enhanced.

Fourth, transmission of the same nonce value can be detected in advance, and thus the problem introduced by the fact that important key values is derived can be solved.

Fifth, security of the ZigBee wireless communication protocol is enhanced, and thus it is possible to implement a ubiquitous environment such as a home network, a process control, a smart grid, an Advanced Metering Infrastructure (AMI), a u-City, or the like

The present invention improves security vulnerability of a ZigBee wireless communication protocol used in a home network, a sensor network, or the like, thereby providing a safe and reliable ZigBee wireless communication protocol.

The scope of the present invention is not limited to the embodiment described and illustrated above but is defined by the appended claims. It will be apparent that those skilled in the art can make various modifications and changes thereto within the scope of the invention defined by the claims. Therefore, the true scope of the present invention should be defined by the technical spirit of the appended claims.

1. An apparatus for enhancing security of a ZigBee wireless communication protocol, provided in a node configuring a ZigBee wireless sensor network, wherein the node comprises:
a nonce value analyzing block for analyzing a nonce value for transmission packets;
a same-nonce value generation sensing block for confirming whether or not a same nonce value exists in consecutively transmitted packets;
an ACL security block having identification information of another node configuring a wireless sensor network and information needed in relation to security; and
a replay attack detecting block for retransmitting a packet transmitted from a specific node in order to prevent a replay attack.

2. The apparatus as claimed in claim 1, wherein the node configuring the ZigBee wireless sensor network further comprises a group key management and communication control block for providing a group key management function for secure communication between groups or between a group and a gateway.

3. An apparatus for enhancing security of a ZigBee wireless communication protocol, provided in a node configuring a ZigBee wireless sensor network, wherein the node comprises the ACL security block having:
a region for storing information on node identification;
a region for storing a secret key value of a corresponding node;
a region for storing a frame counter value of a packet received from the corresponding node; and
a region for storing a sequence value of an acknowledgement (ACK) signal received from the corresponding node.

4. The apparatus as claimed in claim 1, wherein the ACL security block prevents a replay attack and detects a DDoS attack by managing frame counter information and ACK sequence information of a message transmitted from each sensor node.

5. The apparatus as claimed in claim 1, wherein the ACL security block enables group key-based many-to-many secure communication by storing and managing ID information of a sensor node configuring the sensor network and secret key value information allowing secure communication with the sensor node.

6. A method for enhancing security of a ZigBee wireless communication protocol for detecting a replay attack in a ZigBee wireless sensor network in real-time, the method comprising the steps of:
analyzing a received message, extracting a frame counter value, and comparing the frame counter value with a stored frame counter list;
determining possibility of a replay attack by comparing the frame counter value of the newly received message with frame counter storage information of N previously received messages; and
comparing the frame counter value of the newly received message with a stored frame counter value if it is determined that there is possibility of the replay attack,
wherein a corresponding message is dropped depending on a result of the comparison.

7. The method as claimed in claim 6, wherein in the step of determining the possibility of the replay attack, if the frame counter value of the newly received message is equal to a largest existing value+1 or is a value for stuffing of an empty frame counter, it is determined that there is no possibility of the replay attack, and the corresponding frame counter list is updated.

8. The method as claimed in claim 6, wherein in the step of comparing the frame counter value of the newly received message with the stored frame counter value, if the frame counter value of the newly received message exists in the previously stored frame counter value list, it is determined that the replay attack has been made, and a corresponding message is dropped.

9. The method as claimed in claim 6, wherein in the step of comparing the frame counter value of the newly received message with the stored frame counter value, if the frame counter value of the received message is larger by two or more than the stored frame counter value and smaller than or equal to N-threshold, it is determined whether or not a routing transmission delay has occurred for a specific packet, and if the routing transmission delay has not occurred, this means that the replay attack has been made, and a monitoring center is informed of the occurrence of the replay attack.

10. The method as claimed in claim 6, wherein in the step of comparing the frame counter value of the newly received message with the stored frame counter value, if the frame counter value of the received message is larger by N-threshold or more than the stored frame counter value, it is determined that a DDoS attack has been made, and a corresponding message is dropped.

11. A method for enhancing security of a ZigBee wireless communication protocol for managing a group key for many-to-many secure communication between ZigBee nodes in a ZigBee wireless sensor network, the method comprising the steps of:
confirming information on a network configuration state;
setting node ID and a corresponding secret key value of each node to be suitable for the network configuration state;
performing secure communication using the secret key value of a corresponding node; and
determining whether or not there is a change in the network configuration, and processing information on a corresponding node and a key value of the node depending on a result of the determination.

12. The method as claimed in claim 11, wherein in the step of determining whether or not there is the change in the network configuration, if it is determined that a new node has joined the network, information on the corresponding node and a key value of the node are stored, and if an existing node leaves the network, the information on the node and the key value of the node are deleted.

13. A method for enhancing security of a ZigBee wireless communication protocol for confirming a same nonce value for consecutive transmission messages in a ZigBee wireless sensor network, the method comprising the steps of:
analyzing packets transmitted to a wireless transceiver;
confirming whether or not same nonce value information (source address, frame_counter, and security control) is transmitted in two or more packets when ZigBee transmission packets are configured and transmitted; and
transmitting an error value to a monitoring center if the same nonce value is transmitted.

14. The apparatus as claimed in claim 3, wherein the ACL security block prevents a replay attack and detects a DDoS attack by managing frame counter information and ACK sequence information of a message transmitted from each sensor node.

15. The apparatus as claimed in claim 3, wherein the ACL security block enables group key-based many-to-many secure communication by storing and managing ID information of a sensor node configuring the sensor network and secret key value information allowing secure communication with the sensor node.
